(19) United States
(12) Patent Application Publication
(10) Pub. No.: US 2021/0301235 A1
(43) Pub. Date: Sep. 30, 2021

(54) MULTI-STAGE SPIRIT FILTER

(71) Applicant: Jubin JACOB, Toronto (CA)

(72) Inventor: Jubin JACOB, Toronto (CA)

(21) Appl. No.: 16/829,177

(22) Filed: Mar. 25, 2020

(51) Int. Cl. C12H 1/04; B01D 15/36; C12H 1/044

(52) U.S. Cl. CPC C12H 1/0432; C12H 1/0408; B01D 15/363; B01D 15/362

(57) ABSTRACT

The present disclosure relates to a filter designed to purify alcohol, particularly spirits, and more specifically to a reusable multi stage spirit filter. The filter unit is adapted to connect with two fluid containers, the filter adapted receive commercial filter cartridges of the be a refillable filter. Typical filter materials being selected from activated charcoal or carbon, or an ion exchange resin. The reusable filter that can be repeatedly used to clean or polish spirits to remove the impurities thereby improving the taste of spirits.

### FIELD OF THE INVENTION

The present disclosure relates to a filter designed to purify alcohol, particularly spirits, and more particularly to a reusable multi stage spirit filter.

### BACKGROUND

Beer, wine and spirits contain volatile and nonvolatile flavor compounds. Most of the compounds that occur in alcoholic beverages can be grouped according to whether they are distilled with alcohol and steam, or not. Volatile compounds include aliphatic carbonyl compounds, alcohols, monocarboxylic acids and their esters, nitrogen- and sulphur-containing compounds, hydrocarbons, terpenic compounds, and heterocyclic and aromatic compounds. Nonvolatile extracts of alcoholic beverages comprise unfermented sugars, di- and tribasic carboxylic acids, coloring substances, tannic and polyphenolic substances, and inorganic salts.

The flavour composition of alcoholic beverages and distillates generally originate from three sources: raw materials, fermentation and the wooden casks in which they are matured. During maturation, unpleasant flavors, probably caused by volatile sulphur compounds, disappear. Studies into the maturation of distillates in oak casks have shown that many compounds are liberated by alcohol from the walls of the casks. For example, lignin plays an important role and is responsible for the occurrence of some aromatic aldehydes and phenolic compounds, together with monosaccharides (pentoses, quercitol), carboxylic acids and ‘whisky lactone’ (5-butyl-4-methyldihydro-2(3H)-furanone). The occurrence of certain aromatic compounds is indicative of the degradation and oxidation of lignin.

The distillation procedure influences the occurrence and concentration of volatile flavor compounds in the distillate. Particularly in the manufacture of strong spirits, it is customary to improve the flavor of the distillate by stripping it of low-boiling and high-boiling compounds to a greater or lesser degree. Typically the more expensive spirits are extensively distilled and filtered, whereas the cheaper spirits are distilled and filtered less.

It is known that alcohol filtering with carbon, after the distillation process, will clean or polish the spirit by removing impurities. The impurities are what cause a harsh taste and smell. When alcohol is passed through a carbon filter, often at low temperatures, the alcohol becomes a smooth clean pure product. High end vodkas are filtered with activated carbon many times to produce the pure clean neutral spirit. Carbon filtering of numerous spirits is a known method to improve the taste and smell of an average spirit.

CN203820755 discloses a distilled spirit filtering device comprising a filtering machine shell having a pre-treatment filter, equipped with activated carbon, and an after-treatment filter. A liquid inlet is formed in one side of the upper end of the filtering machine shell, and a liquid outlet is formed in the bottom end of the filtering machine shell; a control valve is arranged on the liquid outlet; the pre-treatment filter and the after-treatment filter are divided by a division plate; a plurality of through holes are formed in the division plate; the pre-treatment filter is positioned at the upper end of the after-treatment filter.

U.S. Pat. No. 5,616,242 discloses an apparatus for filtering sediment from beverages, especially port and other fine wines, comprising a cork or stopper member having a central aperture; a tube disposed through said central aperture of said cork or stopper, said tube having a first end and a second end; a first filter member disposed generally around and extending from one end of said tube, forming a junction with said tube, said first filter member being of a fine mesh for straining solids and sediment; and a second filter member interposed at or about said junction of said filter member and said tube, said second filter member being of a finer mesh than the mesh of said first filter member.

U.S. Pat. No. 4,181,243 discloses a filter element at the inlet of a spigot for dispensing beverages from a reservoir or cooler. The filter mechanism preferably includes an open, cup-shaped member which is desirably threaded to the inlet shaft of the spigot to act as a fastener for mounting the spigot to the reservoir. The filter element is quickly insertable into and removable from the filter receiving member by a push fit. The preferred filter element includes two apertured end walls, filter paper positioned immediately adjacent the inner faces of each of the apertured end plates, and activated charcoal between the filter paper.

U.S. Pat. No. 8,197,771 discloses a portable water filtration system that interconnects two, otherwise separate, water bottles arranged vertically such that water flows under gravitational pressure from a first water bottle through a filter configured to capture small particle impurities to a second water bottle and removes small particle impurities before they enter the second water bottle. The filtration system is implemented within a cap that can attach to a variety of standard water bottles. A removable connector ring attaches to the cap to connect a second water bottle to the system. When vertically aligned, water flows from a first water bottle through the filter element in the cap to the second water bottle to remove small and large particles.

CA2727383 discloses a beverage maker including a brew system, an indicator to indicate at least one of a cleaning and a maintenance need of the beverage maker, and a control circuit. The brew system may include a reservoir to receive a liquid, a heater to heat the liquid, an expendable filter structured to filter impurities from the liquid for at least a predetermined number of brew cycles, and a container for receiving a beverage brewed from the filtered liquid. The beverage maker can comprise a filter dipstick configured to comprise a filter, such as a charcoal filter, the filter can be configured to filter impurities out of the liquid as the liquid is drawn though the receiving aperture and used to brew a beverage.

U.S. Ser. No. 10/278,534 discloses a system for steeping beverages. The system includes a filtration unit and dispensing mechanism with a steeping vessel. The dispensing mechanism includes a disk with apertures and a sleeve. The sleeve is coupled to the filtration unit and moves down and up within the steeping vessel to a closed and open position, respectively. With the dispensing mechanism in the closed position the sleeve engages the disk and holds a steeped liquid within the filtration unit. In the open position the sleeve disengages the disk allows the steeped liquid to flow into a capturing vessel through the apertures. The filtration unit includes a first filter that forms a first reservoir and a second filter with a cup structure that forms a second reservoir. The first filter is preferably seated within the cup structure, thereby, forming a double filtration unit. The first filter is preferably made from stainless steel that is perforated with holes and the second filter preferably includes an etched glass frit that is seated in or supported by the cup structure. In accordance with this embodiment, the second filter is capable of filtering finer particulate matter than that of the first filter.

CN205345823 discloses a steeping wine bottle, including a first filter mantle, second filter mantle, wine tap, sealed lid and stopper. The first filter mantle is obconic, the second filter mantle is cylindrical. The utility model discloses that the first and second filters mantle are arranged such that the dregs of a decoction or pomace can not block up out the wine tap.

CN105820938 discloses a white spirit filtering device comprising a cylinder-shaped shell, an entry opening formed in the top side of the shell, a spirit outlet formed in the bottom side of the shell, and a valve arranged at the tail end of the spirit outlet. The device has the advantages that it is designed as a multi-layer-nesting structure, multi-stage filtering materials are arranged inside the filtering device, solid objects in filtered white spirit can be removed at a maximum level, and the original flavor of the filtered white spirit is maintained.

U.S. Pat. No. 2,775,350 discloses filters, especially those known as Seitz filters such as are used for biological research and other laboratory work. A double-ended coupling member is provided, adapted at its ends to be connected (as by screwing) the respective necks of two bottles or a like containers, and having an internal flange, or aperture wall, and such coupling is adapted to be assembled on the said containers, with one having a Seitz pad or the like (with or without gauze) clamped between itself and the said flange or aperture wall and the other having- or not having as desired) “‘a packing ring between itself and the flange or wall. In use, the substance to be filtered is placed in the container which is to have the Seitz pad or the like clamped against it, and after the parts are secured together filtration is effected into the’ other container for example in a centrifuge.

US20060216383 discloses a method for filtering an aged distilled spirit to produce an alcoholic beverage. In one embodiment, the spirit is aged for several years in one or more oak lined casks to impart flavoring. The production of an aged, clear vodka, and other spirits, such as whiskey, can also be produced in accordance with the disclosure. Any color imparted during the aging step is subsequently removed via filtering. Diamond filtration can also be employed to improve taste and texture.

CA2669285 discloses a device for treatment and purification of a liquid product, containing a cartridge which consists of the body connectable with the neck of an elastic bottle with the central air feeder, the filter located therein. The invention makes it possible to increase the vodka purification efficiency by arranging a filter in the entire volume of a cartridge and by flowing a liquid product through the equal volume of filtering materials. The vodka contained in the bottle flows through the rough filtering material and through the sorbing agent then through the fine filtering material.

U.S. Pat. No. 3,220,555 discloses relates to a filter containing or made of wood adapted to be fitted into the neck of a glass bottle filled with whisky, so as to filter, age and mellow the whisky, remove bitterness, and enhance flavor and color. It is among the objects of the invention to continue this ageing process after the whisky has been put into a glass bottle. With the ageing filter in position in the neck of the glass bottle, the proximity and contact of the wood with the whisky continues the ageing and mellowing process.

All above cited documents are hereby incorporated by reference.

None of the above cited documents, alone or in combination satisfy the need for a simple reusable filter that can be repeatedly used to clean or polish spirits to remove the impurities thereby improving the taste of spirits.

### BRIEF SUMMARY

It is an object of the invention to provide a multi-stage spirit filter.

In accordance with an aspect of the invention there is provided a multi stage filter device, comprising a first container having a connection member; a second container having a connection member; a filter sized and adapted at a first end to attach to the connection member on the first container, said filter being sized and adapted at a second end to attach to the connection member on the second container; said filter containing one or more filtering components selected from activated charcoal and ion exchange resin, wherein when a fluid to be filtered is introduced into the first container, and the first and second containers and filter are positioned in a vertical orientation, the fluid passes through the filter into the lower container.

In accordance with another aspect of the invention there is provided a method of filtering a fluid using the device of claim 1, comprising the steps: attaching the second container to the second end of the filter; introducing a fluid to be filtered into the first container; attaching the first container to the first end of the filter; and inverting the device, wherein the fluid to be filtered passes through the filter into the second container.

In accordance with another aspect of the invention there is provided a kit for filtering fluid, said kit comprising: a first container having a connection member; a second container having a connection member; a filter sized and adapted at a first end to attach to the connection member on the first container, said filter being sized and adapted at a second end to attach to the connection member on the second container; said filter containing one or more filtering components selected from activated charcoal and ion exchange resin; and instructions for use.

The advantages and features of the present invention will become better understood with reference to the following more detailed description and claims taken in conjunction with the accompanying drawings in which like elements are identified with like symbols.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an assembled item 100 in accordance with one embodiment.

FIG. 2 illustrates an exploded item 200 in accordance with one embodiment.

FIG. 3 illustrates a perspective view of a filter item 300 in accordance with one embodiment of the invention.

FIG. 4 illustrates working examples of item 400 in accordance with several embodiments of the invention.

FIG. 5 illustrates an assembled item 500 in accordance with one embodiment.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The present disclosure describes two containers in fluid communication configured, when assembled, in a vertical orientation and separated by a filter cartridge. Both of the containers are engaged with the filter cartridge via watertight seals. When a fluid is introduced into the upper container, the fluid percolates through the filter into the lower container. It is contemplated that the device is particularly suited for the filtration of spirits, specifically spirits selected from the group consisting of whisky, vodka, rum, gin, tequila, brandy, schnapps, mezcal, bourbon, scotch, vermouth, absinthe, and soju.

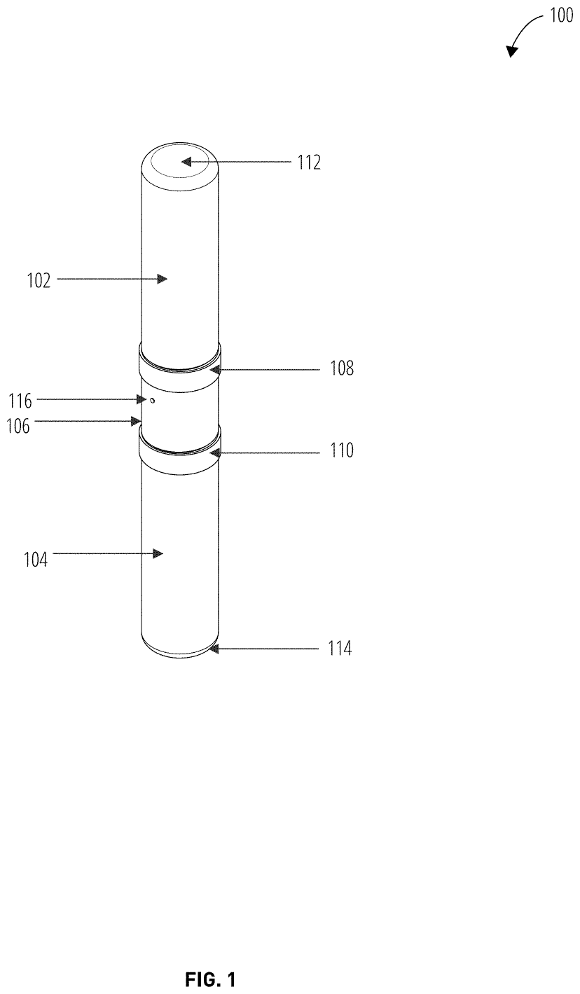

FIG. 1 illustrates an assembled embodiment of the invention. A first container 102 is attached to a filter 106 via a first connector cap 108. A second container 104 is attached to the filter 106 via a second connector cap 110. The first container 102 has a second end of first container 112, which may be open or it may be closed. The second container 104 also has a second end of second container 114 which is typically closed.

The device may also have a built in LED indicator 116, which indicates when the filter requires changing. The indicator may have a series of lights that illuminate in order, corresponding to the number of times the filter has been used. An optional reset controller may be present to allow the operator to switch off the indicator lights, particularly after the filter has been recharged or replaced.

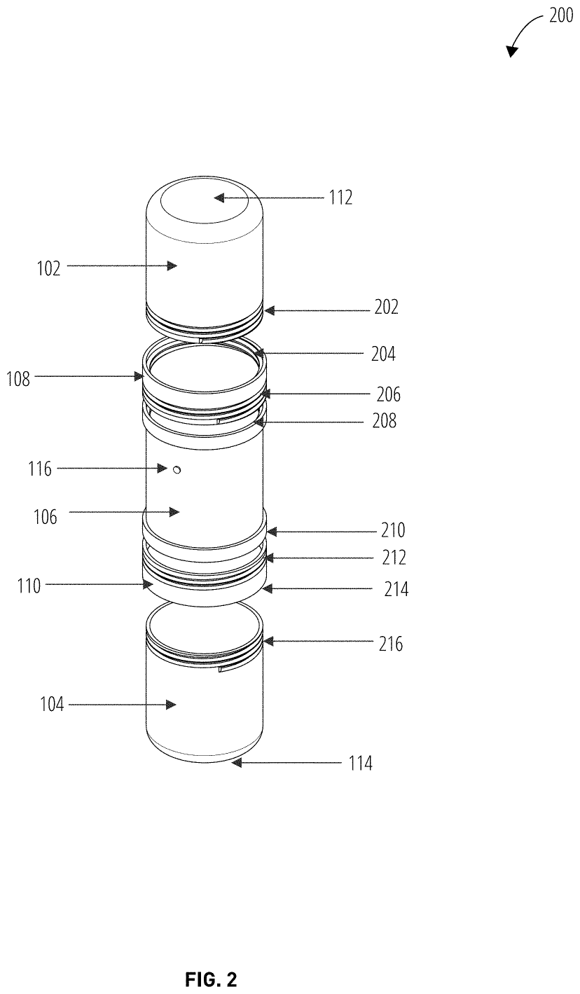

FIG. 2 illustrates an exploded embodiment of the invention. The first container 102 has a connecting means on first end of first container 202 that is sized and shaped to connect with either the connecting means on first end of first connector cap 204 or the connecting means on first end of filter 208.

The second container 104 has a connecting means on first end of second container 216 that is sized and shaped to connect with either the connecting means on first end of second connector cap 214 or the connecting means on second end of filter 210.

The connecting means on second end of first connector cap 206 is sized and shaped to connect with connecting means on first end of filter 208. The connecting means on second end of second connector cap 212 sized and shaped to connect with connecting means on second end of filter 210.

The first connector cap 108 and second connector cap 110 are designed and fabricated to be fluid impermeable. The function of the connector caps, 108 and 110, are two-fold. Firstly, they protect the filter from contamination and damage while not in use, and secondly that allow connection to the first and second containers, 102 and 104, for ease of storage.

When not in use, in an embodiment of the invention, the first container 102 is attached via the connecting means on first end of first container 202 to the first connector cap 108 via the connecting means on first end of first connector cap 204. The first connector cap 108 is attached via the connecting means on second end of first connector cap 206 to the filter 106 via the connecting means on first end of filter 208. The filter 106 is attached via the connecting means on second end of filter 210 to the second connector cap 110 via the connecting means on second end of second connector cap 212. The second connector cap 110 is attached via the connecting means on first end of second connector cap 214 to the second container 104 via the connecting means on first end of second container 216.

When in use, first connector cap 108 and second connector cap 110 are disconnected from the first container 102, second container 104 and filter 106. The first container 102 is attached directly to via the connecting means on first end of first container 202 to the filter 106 via the connecting means on first end of filter 208. The second container 104 is attached directly via the connecting means on first end of second container 216 to the filter 106 via the connecting means on second end of filter 210.

In one embodiment of the invention, the device is assembled for use with a closed second end of second container 114 positioned on a flat surface and the second end of first container 112 open to receive fluid. The fluid to be filtered is poured into the open second end of first container 112 where it percolates through the filter 106, to be collected in the 104.

In operation, the vertical orientation of the filter and meshes permits the meshes adjacent the connecting means on first end of filter 208 and connecting means on second end of filter 210 to act simultaneously as a vent and a filter. Thus, as the fluid flows through the lower portion of the meshes, air can escape through the upper portions of the meshes, thereby equalizing the air pressure within the assembled device 200.

In a further embodiment, the where the second end of first container 112 is sealed, the fluid to be filtered is introduced into the first container 102 when it is inverted. The filter 106 is then threaded onto the first container 102 and the 104 threaded onto the 106. When assembled and all parts are connected in a fluid tight manner, the device is inverted. The fluid then percolated from the first container 102 down through the filter 106 to the second container 104. If additional cycles of filtering are required, the device can be reinverted.

The device may also optionally have a built in LED indicator 116, which indicated when the filter requires changing.

The connecting means are shown in FIG. 2 as cooperating screw threads on the various different parts of the device, but a worker skilled in the art would understand that numerous connection means, such as bayoneted fittings or friction fit connectors used in conjunction with various seals, washers, or gaskets could be substituted.

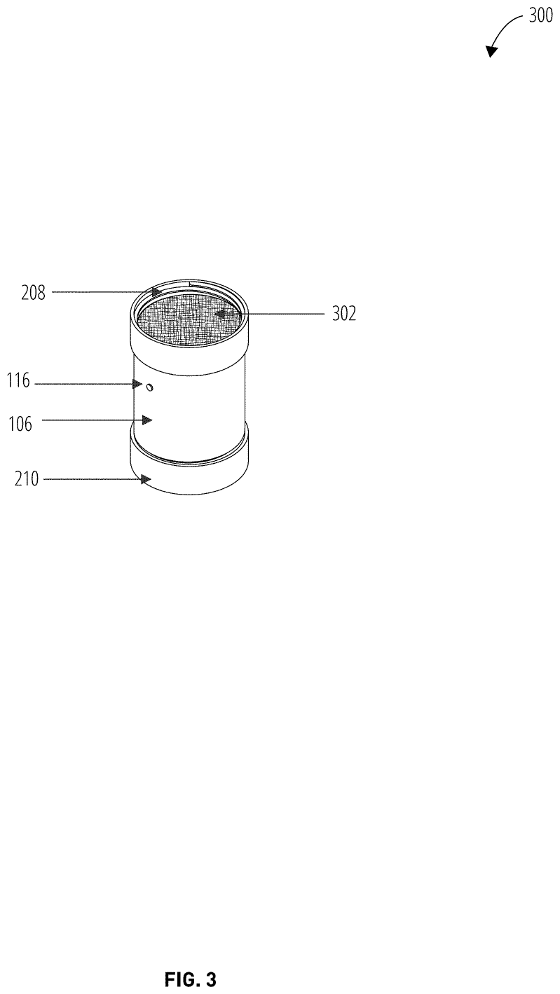

FIG. 3 illustrates an embodiment of the 106. The filter 106 has a mesh retainer 302 situated adjacent the connecting means on first end of filter 208. The filter 106 also has a mesh retainer 302 situated adjacent the connecting means on second end of filter 210 (not shown). The purpose of the mesh retainer 302 is to contain the filtering components within the body of the filter 106.

An optional venting system, not shown, may be present within the filter 106, typically between the mesh retainers. The purpose of the venting system is to relieve any airlocks or vacuums that may build up in the device during use. The vent will accelerate the movement of fluid through the filter components. The vent is not always necessary, as the build up of a slight airlock or vacuum may be a desirable feature, because the slower the fluid moves through the charcoal or resin, the more time there is for impurities to be adsorbed onto the filter components.

The components suitable for filtering fluids, in particular spirits, are selected from the group of charcoals and ion exchange resins. Specifically, activated charcoal and either weak or strong cationic or anionic resins. The resins are typically in the form of beads or micro beads having a radius of between 0.25-0.6 mm. The beads or microbeads are usually made from polyacrylic or polystyrene.

The mesh retainer 302 is chosen such that the gauge of the mesh is sufficient to retain the selected charcoals and/or ion exchange resins in place within the filter 106 during the filtration process.

In alternative embodiments of the invention, the filter 106 is sized to accommodate commercially available filter cartridges.

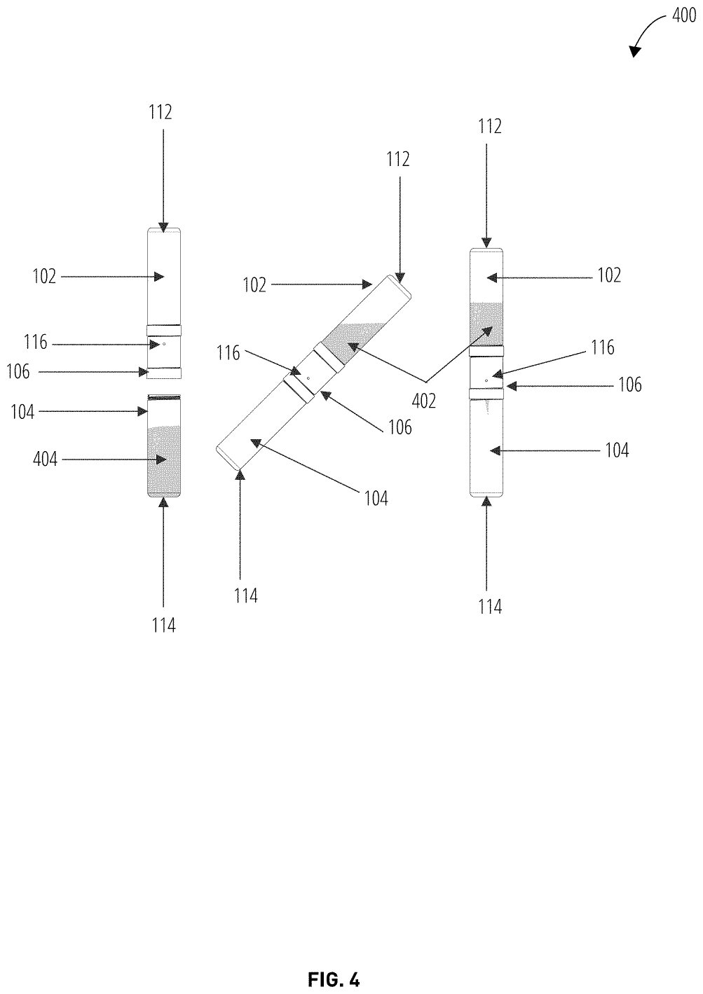

FIG. 4 illustrates an in-use schematic of an embodiment of the device. The devices shown to the left and center indicate positioning of filtered fluid 402 in the first container 102. The filtered fluid 402 percolates through the filter 106 under the force of gravity, into the second container 104. When all of the filtered fluid 402 has passed through the filter 106, the 104 can be separated from the filter 106 and decanted into a storage container (not shown).

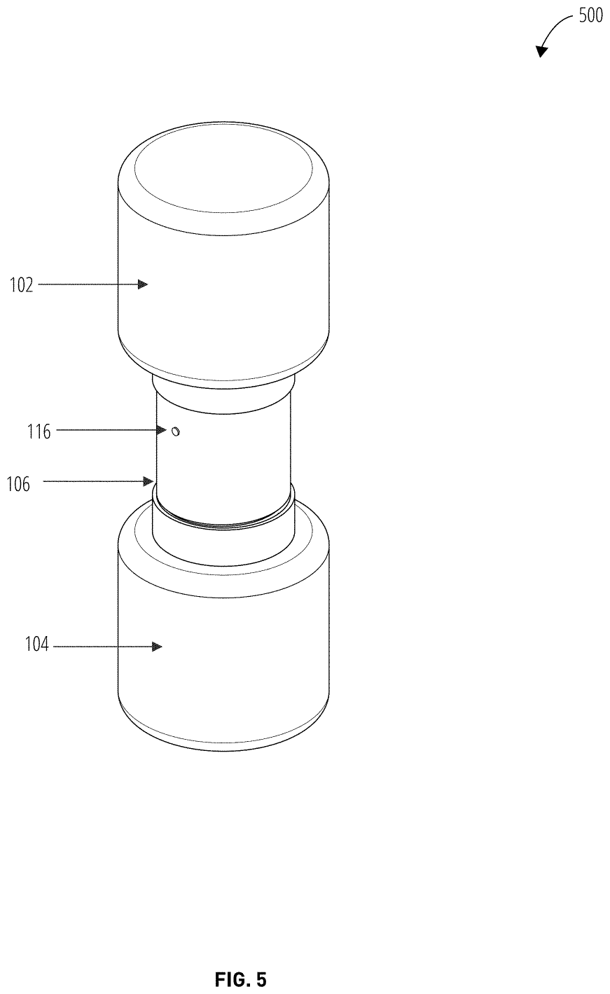

FIG. 5 illustrates a different combination of sizes of first container 102, filter 106 and second container 104. Many other shapes and sizes of parts are contemplated. Typically, the first container 102 and second container 104 are sized to accommodate the contents of a standard 75c1 bottle of spirits. Shorter and wider configurations are designed to fit inside standard refrigerator shelving units.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated without departing from the spirit or scope of the claims of the present invention.

What is claimed is:

1. A multi stage filter device, comprising
a first container having a connection member;
a second container having a connection member;
a filter sized and adapted at a first end to attach to the connection member on the first container, said filter being sized and adapted at a second end to attach to the connection member on the second container; said filter containing one or more filtering components selected from activated charcoal and ion exchange resin,
wherein when a fluid to be filtered is introduced into the first container, and the first and second containers and filter are positioned in a vertical orientation, the fluid passes through the filter into the lower container.

2. The multi stage filter device of claim 1, wherein the filter contains one of more of charcoal, carbon, activated charcoal, activated carbon, cationic ion exchange resin, or anionic ion exchange resin.

3. The multi stage filter device of claim 1, wherein the filter is attached to the connection members on the first and second containers by corresponding screw threads or by a bayonet fitting.

4. The multi stage filter device of claim 1, wherein the fluid to be filtered is introduced into the first container prior to attaching the filter to the second container.

5. The multi stage filter device of claim 1, wherein the first container additionally comprises an opening, said fluid to be filtered is introduced into the first container through the opening.

6. The multi stage filter device of claim 1, further comprising one or more connector caps sized and adapted at a first end to attach to said first and second end of said filter.

7. The multi stage filter device of claim 6, wherein the connector caps are attached at the first end to the filter by corresponding screw threads or bayonet fittings.

8. The multi stage filter device of claim 6, wherein the one or more connector caps have a second end that is sized and adapted to attach to the connection member on said first and second container.

9. The multi stage filter device of claim 8, wherein said one or more connector caps are attached to the first and second containers by corresponding screw threads or bayonet fittings.

10. The multi stage filter device of claim 1, wherein the filter comprises an indicator or a vent.

11. A method of filtering a fluid using the device of claim 1, comprising the steps:
attaching the second container to the second end of the filter;
introducing a fluid to be filtered into the first container;
attaching the first container to the first end of the filter; and
inverting the device, wherein the fluid to be filtered passes through the filter into the second container.

12. The method of filtering a fluid using the device of claim 1, wherein the filter contains one of more of charcoal, carbon, activated charcoal, activated carbon, cationic ion exchange resin, or anionic ion exchange resin.

13. The method of filtering a fluid according to claim 10, wherein the fluid is selected from the group consisting of whisky, vodka, rum, gin, tequila, brandy, schnapps, mezcal, bourbon, scotch, vermouth, absinthe, and soju.

14. A method of filtering a fluid using the device of claim 1, comprising the steps:
attaching the second container to the second end of the filter;
attaching the first container to the first end of the filter; and
introducing a fluid to be filtered into the opening on the first container;
wherein the fluid to be filtered passes through the filter into the second container.

15. The method of filtering a fluid using the device of claim 14, wherein the filter contains one of more of charcoal, carbon, activated charcoal, activated carbon, cationic ion exchange resin, or anionic ion exchange resin.

16. The method of filtering a fluid according to claim 14, wherein the spirit is selected from the group consisting of whisky, vodka, rum, gin, tequila, brandy, schnapps, mezcal, bourbon, scotch, vermouth, absinthe, and soju.

17. A kit for filtering fluid, said kit comprising:
a first container having a connection member;
a second container having a connection member;
a filter sized and adapted at a first end to attach to the connection member on the first container, said filter being sized and adapted at a second end to attach to the connection member on the second container; said filter containing one or more filtering components selected from activated charcoal and ion exchange resin; and
instructions for use.

18. The kit of claim 17, additionally comprising one or more connector caps sized and adapted at a first end to attach to said first and second end of said filter.

19. The kit of claim 17, wherein the one or more connector caps have a second end that is sized and adapted to attach to the connection member on said first and second container.

20. The kit of claim 17, additionally comprising charcoal, carbon, activated charcoal, activated carbon, cationic ion exchange resin, or anionic ion exchange resin for use in the filter.
